(19) United States
(12) Patent Application Publication
(10) Pub. No.: US 2005/0183555 A1
(43) Pub. Date: Aug. 25, 2005

(54) Battery nugget shaver

(76) Inventors: Gabriel Santos, Lawrenceville, GA (US); Russell E. Gyenes, Lawrenceville, GA (US); Due Q. Huynh, Lawrenceville, GA (US)

Correspondence Address: Motorola Energy Systems Group, 1700 Belle Meade Court, Lawrenceville, GA, 30043, US

(21) Appl. No.: 10/783,668

(22) Filed: Feb. 20, 2004

(51) Int. Cl. B26D 1/00

(52) U.S. Cl. 83/13

(57) ABSTRACT

A machine for removing debris from an object, like a battery cell for example, is provided. The machine includes a means for holding the object, and a movable cutting member. The means for holding includes a fixed base and an adjustable, spring loaded loop or belt. One opens the belt by pulling a lever. The object is inserted until one side contacts a leveling plane. Once the object is inserted, another lever actuates a sliding block that causes the blade of the cutting member to slide across the side of the object, thereby shaving off any debris that may be on the object. Once the object is removed from the machine, the newly clean, shaven side is prepared so as to be suitable for manufacturing processes like welding.

### BACKGROUND

1. Technical Field

This invention relates generally to a machine for removing debris from battery cells, and more specifically to a machine that removes metallic debris from the terminals of battery cells.

2. Background Art

Sometimes people think that the battery pack powering their cellular telephone or portable computer is simply a cell or two inside a plastic box. Nothing could be farther from the truth. Today's rechargeable battery packs include a complex array of electrical and mechanical components, including charging circuits, safety circuits, fuel gauging circuits, latches and connectors, just to name a few.

By way of example, a rechargeable battery for a laptop computer may contain eight cells, protection circuitry, fuel gauging circuitry and a microprocessor. Each of these cells must be electrically connected to both the circuitry and the external connector for the overall battery pack to function properly. A popular way to make internal connections within battery packs is with tabs. A tab is a thin, flexible, electrically conductive, metal strip that can be welded to cells and soldered to boards.

Referring now to FIG. 1, illustrated therein is an exemplary cell-tab assembly. A rechargeable cell 1 is shown electrically coupled to a tab 2. A resistance, or spot, welder 3 makes the connection between the cell 1 and the tab 2. This essentially works as follows: the cell 1 is placed into a mechanical fixture and an operator places the tab 2 atop the cell 1. The spot welder 3 is then lowered onto the tab 2, thereby machanically pressing the tab 2 against the cell 1. An electrical current then flows from one electrode 5 of the welder 6, through the tab 2, through the cell 1, back through the tab 2, and into a second electrode 6 of the welder 3. This current flow creates heat, which causes the tab 2 to fuse to the cell 1.

Occasionally, however, as with any manufacturing process, the process proves less than perfect. When this occurs, the weld between the tab 2 and cell 1 may not be sufficiently strong. The operator facing this scenario has two options: scrap the bad cell, resulting in increased cost to his employer, or rework the faulty cell-tab assembly. The latter is generally the chosen option, as manufacturers can ill afford to scrap expensive cells due to faulty weld joints.

The rework process requires that the tab 2 be removed from the cell 1. This is generally done by forcibly tearing the tab 2 from the cell 1. When this is done, turning now to FIG. 2, metal bumps 20, left over from the welding process, remain on the cell 1. These metal bumps 20 must be removed prior to the attachment of another tab for the new weld to be secure. One prior art solution for removing these bumps is by way of a rotary tool with a grinding attachment. Generally speaking, an operator employing this solution takes a small grinding element and grinds off the metal bumps 20.

The problem with this process is that it can be quite destructive to the cells. The grinding, while removing the metal bumps 20, can also remove metal from the cell housing. In come cases, the grinding can even create holes in the cell housing.

There is thus a need for an improved method and apparatus for removing metal debris from battery cells.

### BRIEF DESCRIPTION OF THE DRAWINGS

FIG. 1 illustrates a prior art battery cell-tab assembly.

FIG. 2 illustrates metal debris on a battery cell.

FIG. 3 illustrates a perspective one preferred embodiment of a machine in accordance with the invention.

FIG. 4 illustrates a top, plan view of one preferred embodiment of a machine in accordance with the invention.

FIG. 5 illustrates a side, elevated view of one preferred embodiment of a machine in accordance with the invention.

FIG. 6 illustrates a side, elevated view of one preferred embodiment of a machine in accordance with the invention.

FIG. 7 illustrates a cutting action performed by a machine in accordance with the invention.

FIG. 8 illustrates one method of operating a machine in accordance with the invention.

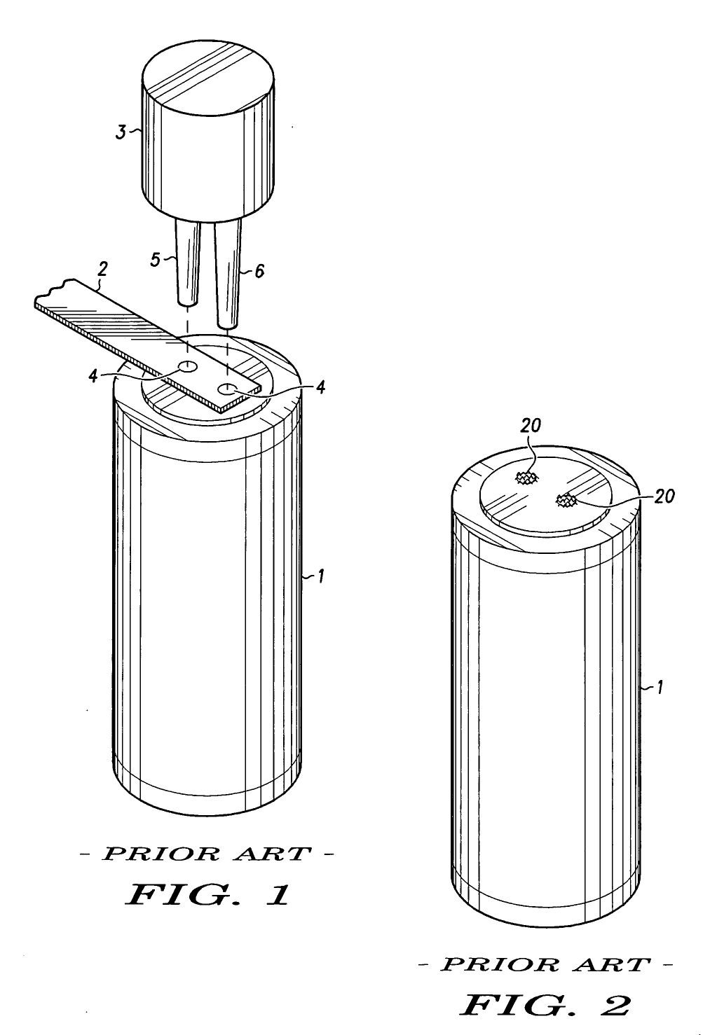

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

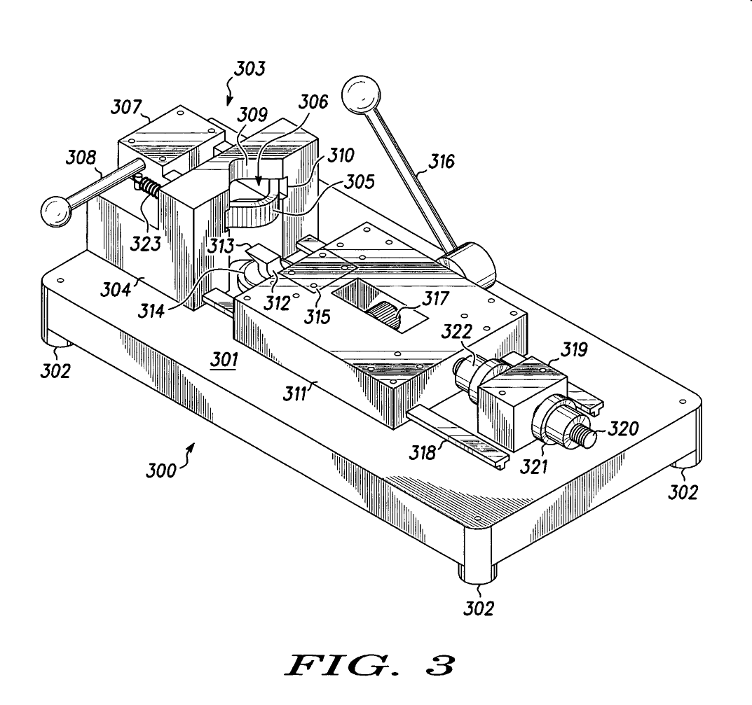

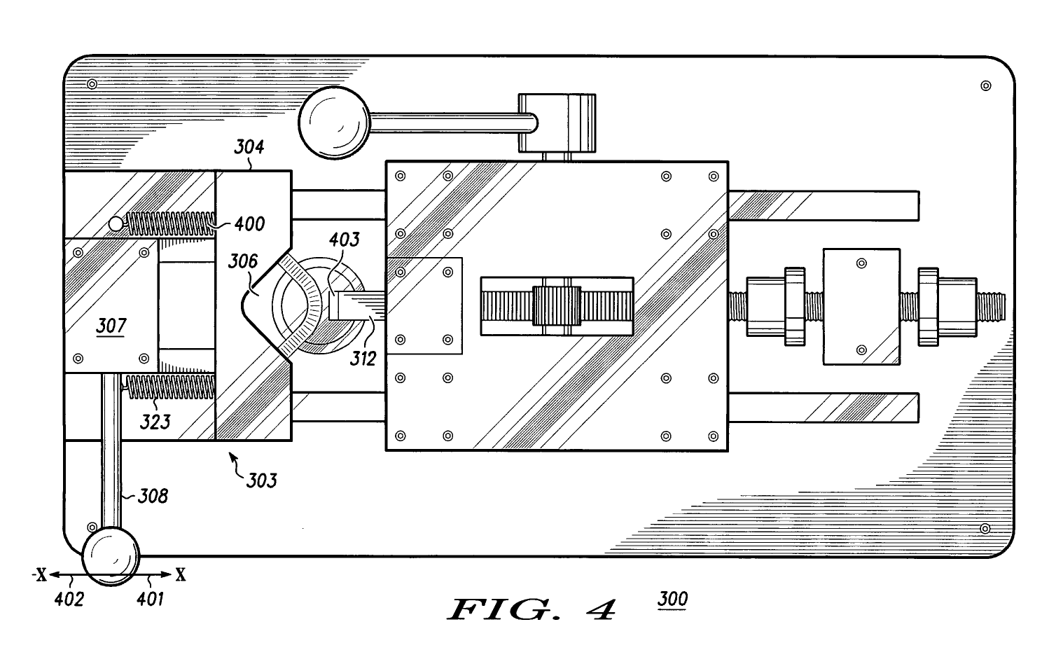

Referring now to FIG. 3, illustrated therein is one preferred embodiment of a machine 300 for removed debris from a battery cell or battery cells. While the exemplary embodiment of FIG. 3 is designed to accommodate a single cell, it will be obvious to those of ordinary skill in the art having the benefit of this disclosure that the machine 300 could be altered to accommodate multiple cells by duplication of parts.

The machine 300 includes a base member 300 for supporting the various elements of the machine. The base member 301 may be mounted on rubber feet 302 to prevent motion while in action. Disposed atop the base member 301 is a means for holding a battery cell 303. The means for holding a battery cell 303 includes a fixed block 304 for accommodating at least one battery cell. The fixed block 304 includes a recess 309 for holding a battery cell. The recess 309 of this exemplary embodiment is suited for holding cylindrical cells, and is thusly cut as a “V” shaped groove. It will be obvious to those of ordinary skill in the art having the benefit of this disclosure that other shapes could be substituted for the V-shaped recess to accommodate cells of other shapes, including rectangles, semi-circles, and squares.

A moveable member, illustrated here as a moveable belt 305, passes through the fixed block 304. The moveable belt 305 forms a complimentary V-shape that opposes that of the recess 309. In so doing, the moveable belt 305 and the recess 309 of the fixed block 304 form a closed loop 306 when viewed from the top. A battery cell may be inserted into this closed loop 306.

As stated, the moveable belt 305 passes through an aperture 301 in the fixed block 304, and is coupled to a moveable support 307. The moveable support 307, and therefore the attached moveable belt 305, are spring loaded against the fixed block 304 by at least one coil spring 309. The coil spring 309 pulls the moveable belt 305 toward the recess 309 when the spring is at rest. A lever 308 coupled to the moveable support 307 allows an operator to open the closed loop 306 by pulling on the lever 308. When the lever 308 is released, the coil spring 309 causes the moveable belt 305 to again pull back into the aperture 310.

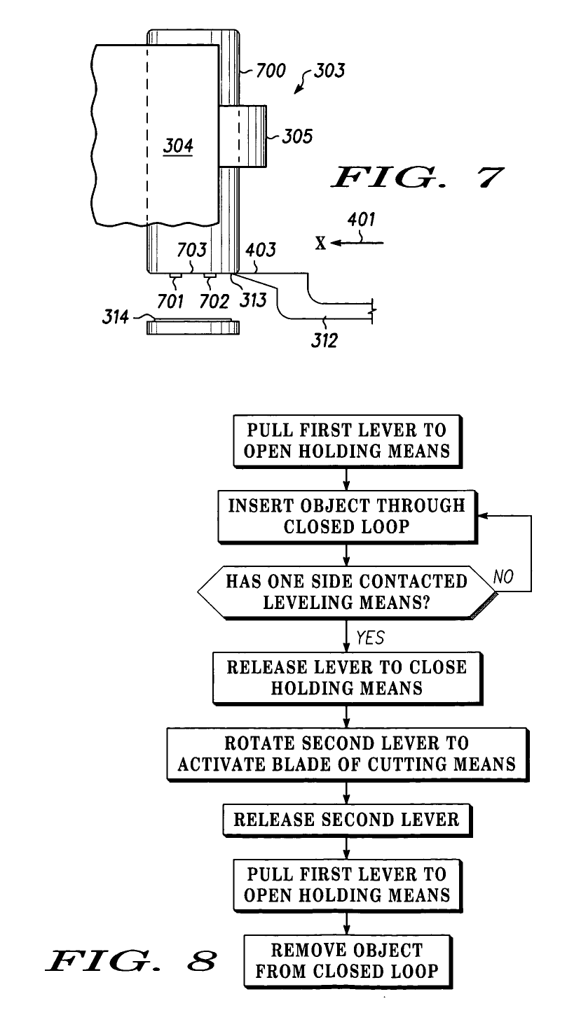

A cutting means 312, having at least one blade 313 coupled thereto, is provided for removing debris from the battery cells. The operation of the cutting means 312 will be described in more detail below with respect to FIGS. 7 and 8. The cutting means 312 is electrically isolated from the means for holding a battery cell 303 to prevent inadvertent short circuits of the battery cell through the machine. The isolation can be achieved in many different ways, including the addition of rubber gaskets between components. One preferred way of electrically isolating the cutting means 312 from the means for holding a battery cell 303 is by anodizing the various components. The anodization electrically insulates each component from another.

A magnet 314 is disposed below the cutting means 312. The magnet 314 serves to “catch” metallic debris that is removed from the surface of the battery cell when the moveable cutting means 312 passes across the cell's surface. While the magnet 314 is optional, it proves extremely effective in keeping the overall workspace clean. The magnet 314 additionally ensures that metallic fragments do not attach themselves to the cell, by static electricity, residual glue, ink or otherwise. Such “sticky fragments” could end up within a battery pack, thereby compromising the reliability of the pack.

The cutting means 312 is mechanically coupled to a sliding member 311. The sliding member travels on rails 312, and moves parallel to the base member 301. A removable blade carrier 315 secures the blade to the sliding member 311 by bolts or other fastening members. The sliding member 311 is actuated by a main lever 316. The main lever 316 is rotatably coupled to the sliding member 311 by a gear assembly 317. Essentially, when the main lever 316 is rotated, the gear assembly 317 actuates, thereby causing the sliding member 311, and thus the cutting member 312, to travel parallel to the base member 301 along the rails 318. It is this parallel travel that allows the blade of the cutting member 312 to pass across at least one surface of the battery cell, thereby removing debris. In other words, actuation of the lever 316 actuates the cutting means 312, thereby causing the cutting means 312 to pass along one end of the battery cell.

The starting point and amount of travel of the sliding member 311 and cutting means is determined by a travel assembly. The travel assembly includes a threaded member 320 coupled to the sliding member 311, a threaded stop 321 disposed about the threaded member 320, a fixed adjustment stop 319 coupled to the base member 301, and a second threaded stop 322. The threaded member 320 passes through the fixed stop 319, and the threaded stop 321 is coupled to the threaded member 320 such that the fixed adjustment stop 319 is disposed between the sliding member 311 and the threaded stop 321.

For removing debris with the push stroke of the lever 316, the preferred method so debris falls to the magnet 314 rather than remaining on the cutting member 312, the starting location of both the sliding member 311 and the cutting member 312 is set by the position of the second threaded stop 322 on the threaded member 320. By twisting the second threaded stop 322 about the threaded member 320, a user may adjust this starting location. Note that the sliding member 311 may optionally be spring loaded to keep the sliding member 311 pushed or pulled towards or away from the means for holding a battery cell 303 in the rest position.

The space between the second threaded stop 322 and the first threaded stop 321, relative to the fixed adjustment stop 319 determines the amount of travel of the sliding member 311. One may adjust the travel of the sliding member 311 by twisting either the threaded stop 321 or second threaded stop 322 about the threaded member 320. This twisting causes the first and second threaded stops 321, 322 to contact the fixed adjustment stop 319 at different points during the motion of the sliding member 311.

Referring now to FIG. 4, illustrated therein is a top, plan view of a machine in accordance with the invention. A second spring 400 can be seen in this view. Two springs 309,400 are useful in that it keeps the travel of the moveable support 307 uniform relative to the fixed member 304.

One inserts a battery cell into the machine 300 by pulling the lever 308 in the X direction 401, thereby opening the closed loop 306. When the battery is inserted into now expanded closed loop 306 of the means for holding a battery 303, the amount if insertion is limited by the leveling means 403 coupled to the cutting means 312. Once the battery cell contacts the leveling means 403, the user releases the lever 308, wherein the springs 309, 400 cause the moveable support to move in the -X direction 402.

The leveling means 403 is essentially a flat surface coupled to the cutting means 312 that limits the amount of insertion, thereby ensuring that the blade of the cutting means 312 aligns properly with a surface of the battery cell. After the battery cell is inserted, this alignment allows the blade of the cutting means 312 to pass cleanly across the surface of the battery cell when the cutting means 312 is actuated. As such, the cutting means “shaves” debris from the surface of the battery cell.

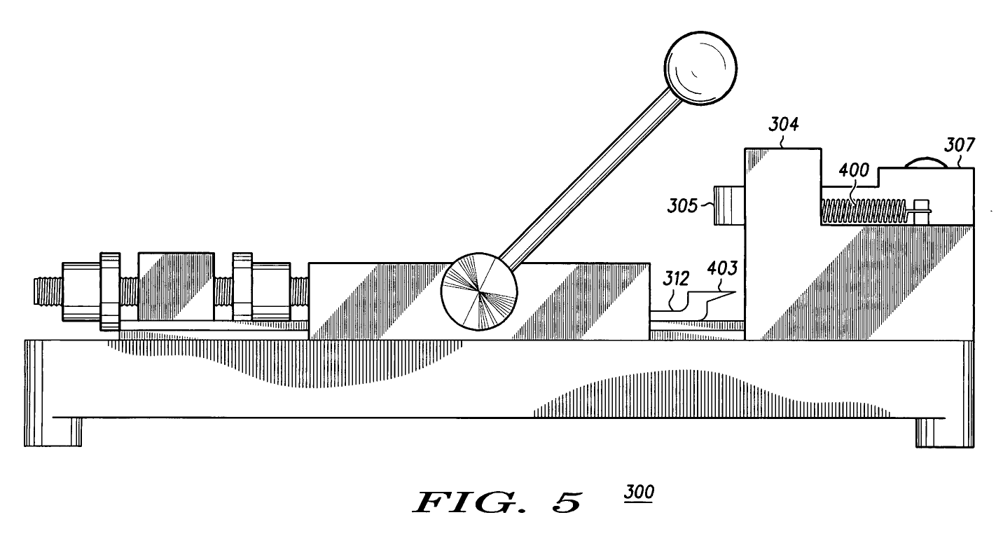

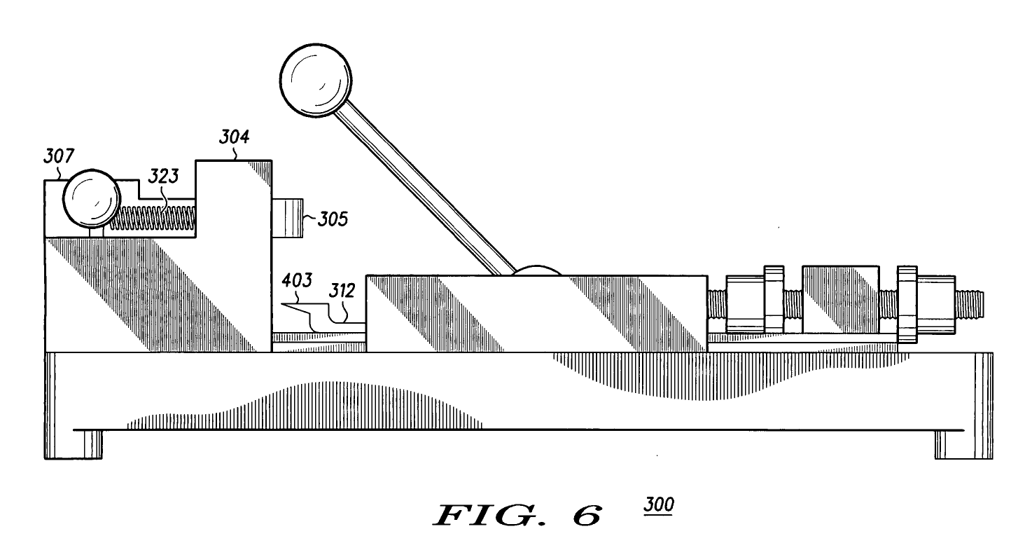

FIGS. 5 and 6 illustrate side, elevated views of the machine. These views provide clearer looks of parts that are seen only fractionally in the perspective view of FIG. 3.

Referring now to FIG. 7, illustrated therein is the cutting action performed by a machine in accordance with the invention. As stated above, after the means for holding a battery cell is opened, a battery cell 700 having metallic debris 701, 702 is inserted into the means for holding a battery cell 303 until one end or edge 703 of the cell touches or otherwise contacts the leveling means 403. Once the means for holding a battery cell 303 has been closed, the cutting means 312 may be actuated. Actuation of the cutting means 312 causes the blade 313 to pass along the end 703 of the battery cell 700, thereby removing debris 701, 702 from the battery cell 700. Once removed, the debris 701, 702 may then fall upon the magnet 314, where it remains magnetically attached until an operator performs a cleaning operation. The method described in this paragraph is illustrated in FIG. 8.

While simple in operation, the machine produced superior and surprising results in practice. The principal improvement was an increase in pull strength resistance of tab-cell assemblies. In other words, cells that were shaved with the machine and then welded to tabs survived larger pull forces without the welds breaking than did new cells that were welded to tabs without having passed through the machine. This result is indicated in Table 1 below.

TABLE 1

| | | | | | | | | Avg. | Avg. |
|---|---|---|---|---|---|---|---|---|---|
| | | Pos. | Neg. | Pos. | Neg. | % | % | Pos. | Neg. |
| | | Term. | Term. | Term. | Term. | Impr., | Impr., | Term. | Term. |
| | Test | w/ | w/ | w/o | w/o | Pos. | Neg. | % | % |
| | Cycle | mach | mach | mach | mach | Term. | Term. | Impr. | Impr. |
| 1 | A2 | 13.8 | 12.8 | 11.89 | 10.88 | 86.12 | 84.99 | | |
| TIME | B2 | 12.5 | 12.1 | 11.56 | 9.06 | 92.51 | 74.84 | | |
| | C2 | 12.7 | 11 | 11.25 | 11.98 | 88.54 | −8.91 | | |
| | D2 | 15.6 | 12.9 | 10.56 | 12.56 | 67.69 | 97.40 | | |
| | E2 | 12.8 | 13.1 | 13.01 | 10.87 | −1.66 | 83.01 | | |
| | AVE | 10.72 | 9.82 | 9.28 | 8.89 | 86.53 | 90.58 | 86.53 | 90.58 |
| | 1 | | | | | | | | |
| 2 | A3 | 13.1 | 12.9 | 11.88 | 9.59 | 90.68 | 74.31 | | |
| TIME | B3 | 13.7 | 12.6 | 11.36 | 9.99 | 82.89 | 79.25 | | |
| | C3 | 13.9 | 13.5 | 11.83 | 11.23 | 85.12 | 83.19 | | |
| | D3 | 14.8 | 12.5 | 10.98 | 10.58 | 74.21 | 84.67 | | |
| | E3 | 12.3 | 12.9 | 11.58 | 11.33 | 94.15 | 87.79 | | |
| | AVE | 13.56 | 12.88 | 11.53 | 10.54 | 85.00 | 81.85 | 85.00 | 81.85 |
| | 2 | | | | | | | | |
| 3 | A4 | 12.5 | 14.1 | 11.57 | 10.84 | 92.55 | 76.89 | | |
| TIME | B4 | 12.9 | 11.9 | 13.56 | 9.98 | −5.13 | 83.90 | | |
| | C4 | 13.6 | 12.3 | 10.56 | 10.58 | 77.66 | 86.04 | | |
| | D4 | 13.8 | 11.8 | 10.23 | 10.57 | 74.13 | 89.56 | | |
| | E4 | 15.5 | 13.8 | 11.95 | 10.99 | 77.11 | 79.60 | | |
| | AVE | 13.66 | 12.78 | 11.58 | 10.59 | 84.74 | 82.88 | 84.74 | 82.88 |
| | 3 | | | | | | | | |
| 4 | A5 | 12.1 | 12.3 | 11.25 | 10.87 | 92.93 | 88.41 | | |
| TIME | B5 | 12.6 | 13 | 11.32 | 11.23 | 89.87 | 86.39 | | |
| | C5 | 12.3 | 11.9 | 10.87 | 10.88 | 88.33 | 91.42 | | |
| | D5 | 13 | 11.7 | 11.25 | 11.26 | 86.50 | 96.20 | | |
| | E5 | 13.5 | 12.1 | 10.99 | 10.32 | 81.40 | 85.30 | | |
| | AVE | 12.7 | 12.2 | 11.13 | 10.91 | 87.67 | 89.44 | 87.67 | 89.44 |
| | 4 | | | | | | | | |

| | | |
|---|---|---|
| Overall Average of Improvement | 85.99 | 86.19 |

As can be seen from the table above, when tests were run on sample sets of five cells, the average increase in pull strength was over 85%, or 1.6 lbs. This increase in pull strength not only increases the reliability of the overall battery pack, but also reduces costs due to customer field returns.

A second improvement realized with the machine was reduced cost in manufacture. The reduced cost came primarily from two sources: First, overall raw material cost was reduced because cells did not have to be scrapped. When a poor weld joint appeared, the machine facilitated refurbishment of the cell surface. A second reduction of cost came from reduced labor time. In contrast to the time consuming rotary tool reworking, the machine facilitated a fast, clean refurbishment cycle.

A third improvement was decreased electrical impedance. When cells were refurbished with the machine, experimental results showed lower electrical impedance from tab to cell. This reduced impedance means that more of the battery cell's energy will be delivered to the host, as opposed to being dissipated as heat in the battery pack.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A machine for removing debris from battery cells, comprising:
a. a means for holding a battery cell; and
b. a cutting means comprising at least one blade;
wherein when a battery cell is inserted into the means for holding a battery cell, and the cutting means is actuated, the at least one blade passes across at least one surface of the battery cell.

2. The machine of claim 1, wherein the cutting means further comprises a leveling means.

3. The machine of claim 2, wherein when a battery cell is inserted into the means for holding a battery cell, the amount of insertion is limited by the leveling means.

4. The machine of claim 1, further comprising a magnet mounted below the cutting means.

5. The machine of claim 1, wherein the means for holding a battery cell comprises a fixed block and a moveable belt.

6. The machine of claim 5, wherein the moveable belt is spring loaded against the fixed block

7. The machine of claim 1, further comprising a sliding member coupled to the cutting means, wherein the sliding member is mounted on rails.

8. The machine of claim 7, wherein the sliding member is coupled to a lever.

9. The machine of claim 8, wherein lever is rotatably connected to the sliding member by way of a gear assembly.

10. The machine of claim 7, further comprising a threaded member coupled to the sliding member, wherein the threaded member passes through a fixed adjustment stop.

11. The machine of claim 10, further comprising a threaded stop disposed about the threaded member such that the fixed adjustment stop is disposed between the sliding member and the threaded stop.

12. The machine of claim 11, wherein travel of the cutting means is adjustable by twisting the threaded stop about the threaded member.

13. The machine of claim 1, wherein the cutting means is electrically isolated from the means for holding a battery cell.

14. A method of removing debris from a battery cell, the method comprising the steps of
a. providing the machine of claim 1;
b. opening the means for holding a battery cell;
c. inserting a battery cell into the means of holding a battery cell until one end of the battery cell touches the leveling means;
d. closing the means for holding a battery cell; and
e. actuating the cutting means, thereby causing the cutting means to pass along the one end of the battery cell.

15. A machine for removing debris from a battery cell, comprising;
a. a base member;
b. a fixed block coupled to the base member, wherein the fixed block includes a recess for holding the battery cell;
c. a moveable belt that is spring loaded against the fixed block such that the recess and the moveable belt form a closed loop; and
d. a moveable cutting means comprising at least one blade;
wherein when the moveable cutting means is moving, the at least one blade travels parallel to the top surface of the leveling means

16. The machine of claim 15, wherein the moveable cutting means further comprises a leveling means.

17. The machine of claim 15, further comprising a magnet disposed below the cutting means.

18. The machine of claim 15, wherein the cutting means is electrically isolated from the fixed block and the moveable belt.
